(19) United States
(12) Patent Application Publication
(10) Pub. No.: US 2026/0332366 A1
(43) Pub. Date: Oct. 22, 2026

(54) METHOD AND APPARATUS FOR EXECUTING INDICATION INFORMATION, METHOD AND APPARATUS FOR SENDING INDICATION INFORMATION, AND DEVICE AND STORAGE MEDIUM

(71) Applicant: Beijing Xiaomi Mobile Software Co., Ltd., Beijing (CN)

(72) Inventor: Ting FU, Beijing (CN)

(21) Appl. No.: 19/112,355

(22) PCT Filed: Sep. 19, 2022
(86) PCT No.: PCT/CN2022/119702

§ 371 Date: Mar. 17, 2025

(51) Int. Cl. H04L 5/00; H04W 72/0457; H04W 72/232

(52) U.S. Cl. CPC H04L 5/0096; H04L 5/0094; H04W 72/0457; H04W 72/232

(57) ABSTRACT

A method for executing indication information is performed by a user equipment, and includes: receiving first indication information, for instructing to enable or disable a spatial unit, transmitted by a network device; performing bandwidth part (BWP) switching; and determining, based on a time occasion, whether to execute the first indication information on a BWP after switching, wherein the time occasion is for receiving the first indication information.

### CROSS REFERENCE TO RELATED APPLICATIONS

This application is a US National Phase of International Application No. PCT/CN2022/119702, filed on Sep. 19, 2022, the entire content of which is incorporated herein by reference.

### TECHNICAL FIELD

The present disclosure relates to the field of communication technologies, in particular to a method and apparatus for executing or transmitting indication information, a device, and a readable storage medium.

### BACKGROUND

In the process of the development of wireless communication technology, how to reduce the energy consumption of a base stations is a hot topic. A method for reducing the energy consumption of a base station is to use a dynamic switch space element, such as an antenna element, a port, a Tron chain (TRX chain), a beam, a panel, a reference signal (RS), etc., but the dynamic switch space element will lead to changes in the actually transmitted reference signals.

A user equipment can perform bandwidth part (BWP) switching, while the user equipment cannot transmit uplink data and receive downlink data in the process of BWP switching. When the BWP switching and a dynamic switching spatial unit are applied at the same time, it is necessary to consider how to determine a state (enabled or disabled state) of the spatial unit on the BWP after switching.

### SUMMARY

According to a first aspect of the embodiments of the present disclosure, there is provided a method for executing indication information, performed by a user equipment, and including: receiving first indication information, for instructing to enable or disable a spatial unit, transmitted by a network device; performing bandwidth part (BWP) switching; and determining, based on a first time occasion, whether to execute the first indication information on a BWP after switching, where the first time occasion is a time occasion for receiving the first indication information.

In some embodiments, receiving first indication information, transmitted by the network device, for instructing to enable or disable the spatial unit includes: receiving downlink control information (DCI) transmitted by the network device, where the DCI includes the first indication information for instructing to enable or disable the spatial unit and second indication information for instructing to perform the BWP switching.

In some embodiments, performing the BWP switching includes: performing the BWP switching in response to receiving the second indication information, for instructing to perform the BWP switching, transmitted by the network device.

In some embodiments, determining, based on the first time occasion, whether to execute the first indication information on the BWP after switching includes: determining that the first time occasion is a time occasion for receiving the DCI; and executing the first indication information on the BWP after switching.

In some embodiments, the method further includes: starting to execute the first indication information at a first time, where the first time is a time corresponding to a set duration after a time for receiving the DCI.

In some embodiments, the method further includes: starting to execute the first indication information at a second time, where the second time is after receiving the DCI and is separated from a time for receiving the DCI by a slot offset indicated by the DCI.

In some embodiments, determining, based on the first time occasion, whether to execute the first indication information on the BWP after switching includes: determining that the first time occasion is before receiving second indication information for instructing to perform the BWP switching; and not executing the first indication information on the BWP after switching.

In some embodiments, performing the BWP switching includes: performing the BWP switching in response to timeout of a BWP switching timer.

In some embodiments, determining, based on the first time occasion, whether to execute the first indication information on the BWP after switching includes: determining that the first time occasion is before the user equipment performs, based on the BWP switching timer, the BWP switching; and not executing the first indication information on the BWP after switching.

In some embodiments, the method further includes: using a default spatial unit on the BWP after switching.

In some embodiments, the spatial unit is one or more reference signals.

According to a second aspect of the embodiments of the present disclosure, there is provided a method for transmitting indication information, performed by a network device, and including: transmitting first indication information, for instructing to enable or disable a spatial unit, to a user equipment; and determining, based on a second time occasion, a spatial unit to be used on a bandwidth part (BWP) obtained after the user equipment performs BWP switching, where the second time occasion is a time occasion for transmitting the first indication information.

In some embodiments, transmitting the first indication information, for instructing to enable or disable the spatial unit, to a user equipment includes: transmitting downlink control information (DCI) to the user equipment, where the DCI includes the first indication information for instructing to enable or disable the spatial unit and second indication information for instructing to perform the BWP switching.

In some embodiments, determining, based on the second time occasion, the spatial unit to be used on the BWP obtained after the user equipment performs the BWP switching includes: determining a second time occasion as a time occasion for transmitting the DCI; and enabling the spatial unit, to be enabled as instructed by the first indication information, on the BWP after switching, or disabling the spatial unit, to be disabled as instructed by the first indication information, on the BWP after switching.

In some embodiments, the method further includes: transmitting second indication information for instructing to perform the BWP switching after transmitting the first indication information to the user equipment.

In some embodiments, determining, based on the second time occasion, the spatial unit to be used on the BWP obtained after the user equipment performs the BWP switching includes: determining that the second time occasion is before transmitting the second indication information; and using a default spatial unit on the BWP after switching.

In some embodiments, determining, based on the second time occasion, the spatial unit to be used on the BWP obtained after the user equipment performs the BWP switching includes: determining that the second time occasion is before the user equipment performs, based on the BWP switching timer, the BWP switching; and using a default spatial unit on the BWP after switching.

According to a third aspect of the present disclosure, there is provided an electronic device, including a processor and a memory, where the memory is configured to store computer programs; and the computer programs, when executed by the processor, cause the processor to perform the method according to the first aspect.

According to a fourth aspect of the present disclosure, there is provided an electronic device, including a processor and a memory, where the memory is configured to store computer programs; and the computer programs, when executed by the processor, cause the processor to perform the method according to the second aspect.

According to a fifth aspect of the present disclosure, there is provided a non-transitory computer-readable storage medium, storing instructions thereon, where the instructions, when executed by a computer, cause the computer to perform the method according to the first aspect.

According to a sixth aspect of the present disclosure, there is provided a non-transitory computer-readable storage medium, storing instructions thereon, where the instructions, when executed by a computer, cause the computer to perform the method according to the second aspect.

It is to be understood that the above general descriptions and the below detailed descriptions are merely exemplary and explanatory, and are not intended to limit the present disclosure.

### BRIEF DESCRIPTION OF THE DRAWINGS

The drawings described here are used to provide a further understanding of the present specification and constitute a part of the present disclosure. The schematic implementations of the present disclosure and the description thereof are used to explain the present disclosure, and do not constitute an improper limitation on the present disclosure.

The accompanying drawings, which are incorporated in and constitute a part of this specification, illustrate embodiments consistent with the present disclosure and, together with the description, serve to explain the principles of the disclosure.

FIG. 1 is a schematic diagram illustrating a wireless communication system architecture according to an embodiment of the present disclosure.

FIG. 2 is a schematic diagram illustrating a process of transmitting and executing indication information according to an embodiment of the present disclosure.

FIG. 3 is a schematic diagram illustrating a process of transmitting and executing indication information according to an embodiment of the present disclosure.

FIG. 4 is a schematic diagram illustrating a process of performing BWP switching according to an embodiment of the present disclosure.

FIG. 5 is a schematic diagram illustrating a process of transmitting and executing indication information according to an embodiment of the present disclosure.

FIG. 6 is a flowchart illustrating a method for executing indication information according to an embodiment of the present disclosure.

FIG. 7 is a flowchart illustrating a method for transmitting indication information according to an embodiment of the present disclosure.

FIG. 8 is a structural schematic diagram illustrating a user equipment according to an embodiment of the present disclosure.

FIG. 9 is a structural schematic diagram illustrating a user equipment according to another embodiment of the present disclosure.

FIG. 10 is a structural schematic diagram illustrating a network device according to an embodiment of the present disclosure.

FIG. 11 is a structural schematic diagram illustrating a network device according to another embodiment of the present disclosure.

### DETAILED DESCRIPTION OF THE EMBODIMENTS

The embodiments of the present disclosure will be further described in detail below in conjunction with accompanying drawings and specific examples.

Examples will be described in detail herein, with the illustrations thereof represented in the drawings. Where the following description relates to the drawings, unless otherwise indicated, the same numerals in different drawings represent the same or similar elements. The embodiments described in the following exemplary embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

Hereinafter, the embodiments of the present disclosure will be described in detail, examples of which are illustrated in the accompanying drawings, where the same or similar reference numerals indicate the same or similar elements throughout. The embodiments described below by reference to the accompanying drawings are exemplary and are intended to explain the present disclosure and are not to be construed as limiting the present disclosure.

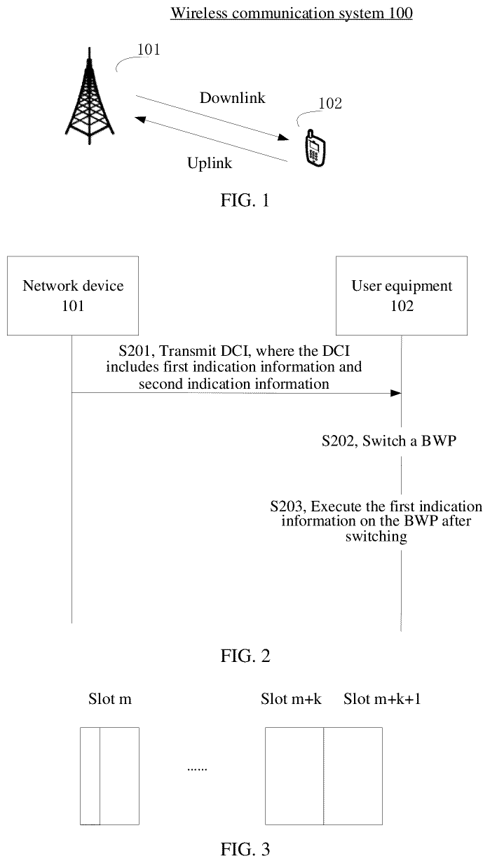

As shown in FIG. 1, an embodiment of the present disclosure provides a method for executing indication information that can be applied to a wireless communication system 100, which may include, but is not limited to, a network device 101 and a user equipment 102. The user equipment 102 is configured to support carrier aggregation, and the user equipment 102 may be connected to a plurality of carrier units of the network device 101, including a primary component carrier unit and one or more secondary component carrier units.

It will be understood that the wireless communication system 100 may be suitable for both low frequency and high frequency scenes. The application scenes of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) systems, a future 5th-generation (5G) system, a new radio (NR) communication system, a future evolved public land mobile network (PLMN) system, and other systems.

The user equipment 102 may be a user equipment (UE), a terminal, an access terminal, a terminal unit, a terminal station, a mobile station (MS), a remote station, a remote terminal, a mobile terminal, a wireless communication device, a terminal agent, etc. The user equipment 102 may have a wireless receiving and transmitting function, which is capable of communicating (e.g., wireless communication) with one or more network devices 101 of one or more communication systems and accepting network services provided by the network devices 101, which herein include, but are not limited to, a base station illustrated.

The user equipment 102 may be a cellular telephone, a cordless telephone, a session initiation protocol (SIP) telephone, a wireless local loop (WLL) station, a personal digital assistant (PDA) device, a handheld device with wireless communication capabilities, a computing device, other processing devices connected to wireless modems, an on-board device, a wearable device, a user equipment in a future 5G network or in a future evolved PLMN network, and so on.

The network device 101 may be an access network device (or access network station). The access network device is a device that has the function of providing network access, such as a radio access network (RAN) base station and the like. The network device may include a base station (BS) device, or include a BS device and a wireless resource management device for controlling the BS device, and the like. The network device may also include relay stations (relay devices), access points, and base stations in the future 5G network, and base stations or NR base stations in the future evolved PLMN network, and the like. The network device may be a wearable device or an on-board device. The network device can also be a communication chip with a communication module.

For example, the network device 101 includes, but is not limited to, a next-generation base station (gnodeB, gNB) in 5G, an evolved node B (cNB) in an LTE system, a radio network controller (RNC), a node B (NB) in a wideband code division multiple access (WCDMA) system, a wireless controller in a centralized radio access network (CRAN) system, a base station controllers (BSC), a base transceiver station (BTS) in a global system for mobile communication (GSM) or code division multiple access (CDMA) system, and a home base stations (e. g, home evolved node B, or home node B (HNB)), a baseband unit (BBU), a transmitting and receiving point (TRP), a transmitting point (TP), or a mobile switching center.

Considering that the frequency domain resources used by the user equipment will change accordingly after the BWP switching, the user equipment needs to determine whether the first indication information for instructing to enable or disable the spatial unit is applicable to the BWP before switching or the BWP after switching. If it is applicable to the BWP before switching, the first indication information can be ignored. If it is applicable to the BWP after switching, the first indication information is executed. Therefore, the user equipment can respond to, on the appropriate BWP, the indication, for dynamically enabling the spatial unit, from the network device in the BWP switching scenario, and this prevents the user equipment from not responding to, on the BWP expected by the network device, the indication, for dynamically enabling the spatial unit, from the network device due to the BWP switching, or this prevents the user equipment from responding to, on the BWP not expected by the network device, the indication, for dynamically enabling the spatial unit, from the network device.

When determining which BWP the first indication information is applicable to, it can be determined based on the time occasion of receiving the first indication information.

An embodiment of the present disclosure provides a method for executing indication information. FIG. 2 is a flowchart illustrating a method for executing indication information according to the embodiment of the present disclosure. As shown in FIG. 2, the method includes the following steps S201 to S203.

At step S201, the network device transmits downlink control information (DCI) to the user equipment, where the DCI includes the first indication information for instructing to enable or disable the spatial unit and second indication information for instructing to perform the BWP switching.

At step S202, the user equipment switches a BWP.

In some embodiments, switching the BWP can be expressed as performing the BWP switching, At step S203, the user equipment executes the first indication information on the BWP after switching. The network device enables the spatial unit, to be enabled as instructed by the first indication information, on the BWP after switching, or disables the spatial unit, to be disabled as instructed by the first indication information, on the BWP after switching.

In some embodiments, the user equipment starts to execute the first indication information at a first time t1, where the first time t1 is a time corresponding to a set duration after a time for receiving the DCI. For example, if the time of receiving the DCI is t0 and the duration is set to T, the first time t1 is t0+T.

In some embodiments, the user equipment starts to execute the first indication information at a second time t2, where the second time t2 is after receiving the DCI and is separated from a time for receiving the DCI by a slot offset indicated by the DCI. For example, as shown in FIG. 3, the physical downlink control channel (PDCCH) of the DCI for indicate the BWP switching is located within the first three symbols of slot m. The user equipment performs switches from BWP1 to BWP2 and uses BWP2 in slot n. When a slot offset indicated by the DCI occupies k slots, the time corresponding to the slot offset indicated by the DCI is the end time of slot m+k.

In some embodiments, the spatial unit is one or more reference signals. Alternatively, the spatial unit may be an antenna element, a port, a TRX chain, a beam, or a panel.

In the embodiments of the present disclosure, the way in which the network device transmits the first indication information for instructing to enable or disable the spatial unit and the second indication information for instructing to switch BWP in the same DCI can indicate that the spatial unit to be enabled or disabled as instructed in the first indication information is applicable to the BWP obtained after switching, so that the user equipment can execute the first indication information on the BWP obtained after performing the BWP switching.

The user equipment determines, based on the time occasion for receiving the first indication information, whether to execute the first indication information, transmitted by the network device, on the BWP obtained after switching, so that in the BWP switching scenario, the user equipment responds to, on the appropriate BWP, the indication, for dynamically enabling the spatial unit, from the network device, and this prevents the user equipment from not responding to, on the BWP expected by the network device, the indication, for dynamically enabling the spatial unit, from the network device due to the BWP switching, or this prevents the user equipment from responding to, on the BWP not expected by the network device, the indication, for dynamically enabling the spatial unit, from the network device. The network equipment determines whether to open or close the spatial unit indicated by the first indication information on the switched BWP through the opportunity of sending the first indication information, so that the network equipment and the user equipment have the same operation for opening or closing the spatial unit in the BWP switching scenario of the user equipment.

An embodiment of the present disclosure provides a method for executing indication information, and the method includes the following steps S201 to S203.

At step S201, the network device transmits the DCI to the user equipment, where the DCI includes second indication information and third indication information, the second indication information is configured to instruct to switch a BWP (perform BWP switching), and the third indication information is configured to instruct to enable at least one spatial unit and to disable at least one spatial unit.

At step S202, the user equipment switches a BWP.

At step S203, the user equipment executes the third indication information on the BWP after switching. The network device enables the spatial unit, to be enabled as instructed by the third indication information, on the BWP after switching, and disables the spatial unit, to be disabled as instructed by the third indication information.

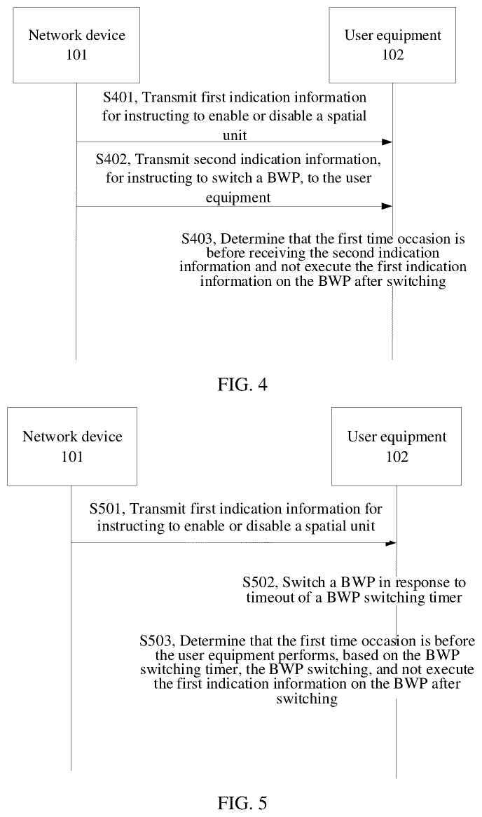

An embodiment of the present disclosure provides a method for executing indication information. FIG. 4 is a flowchart illustrating a method for executing indication information according to the embodiment of the present disclosure. As shown in FIG. 4, the method includes the following steps S401 to S403.

At step S401, the network device transmits first indication information for instructing to enable or disable a spatial unit to a user equipment.

At step S402, the network device transmits second indication information, for instructing to switch a BWP, to the user equipment.

At step S403, the user equipment determines that the first time occasion is before receiving the second indication information and does not execute the first indication information on the BWP after switching. The first time occasion is a time occasion for receiving the first indication information.

In some embodiments, the step S403 further includes: using, by the user equipment and the network device, a default spatial unit on the BWP after switching.

In an embodiment, different spatial units can be configured for different BWPs when configuring spatial units. In the scenario of switching BWP on the user equipment, some spatial units can be configured on the BWP before switching, and other spatial units can be configured on the BWP after switching. When configuring spatial units, the concept of “spatial unit group” can be used or not used, and one or more spatial units can be configured without using the concept of “spatial unit group”. If the user equipment has already been configured with a plurality of default “spatial unit groups” on the BWP after switching, the default spatial unit in step S403 refers to the spatial unit in the default spatial unit group, where the default spatial unit group is agreed upon by the protocol or configured by the network device (for example, the default spatial unit group is a spatial unit group 0). If the user equipment is not configured with any spatial unit group on the BWP after switching, that is, no spatial unit group is configured, the default spatial unit in step S403 refers to all spatial units configured on the BWP after switching.

In some embodiments, the spatial unit is one or more reference signals.

In some embodiments, the spatial unit may be an antenna element, a port, a TRX chain, a beam, or a panel.

In the embodiments of the present disclosure, the way in which the network device transmits the second indication information after transmitting the first indication information can indicate that the spatial unit to be enabled or disabled as instructed in the first indication information is only applicable to the BWP before switching, so that the user equipment does not execute the first indication information after performing the BWP switching.

An embodiment of the present disclosure provides a method for executing indication information, and the method includes the following steps S401′ to S403′.

At step S401′, The network device transmits third indication information to the user equipment, where the third indication information is configured to instruct to enable at least one spatial unit and to disable at least one spatial unit.

At step S402′, the network device transmits second indication information, for instructing to switch a BWP, to the user equipment.

At step S403′, the user equipment determines that the first time occasion is before receiving the second indication information and does not execute the third indication information on the BWP after switching. The first time occasion is a time occasion for receiving the first indication information.

In some embodiments, the step S403′ further includes: using, by the user equipment and the network device, a default spatial unit on the BWP after switching.

An embodiment of the present disclosure provides a method for executing indication information. FIG. 5 is a flowchart illustrating a method for executing indication information according to the embodiment of the present disclosure. As shown in FIG. 5, the method includes the following steps S501 to S503.

At step S501, the network device transmits first indication information for instructing to enable or disable a spatial unit to a user equipment.

At step S502, the user equipment switches a BWP (performs BWP switching) in response to timeout of a BWP switching timer.

At step S503, the user equipment determines that the first time occasion is before the user equipment performs, based on the BWP switching timer, the BWP switching; and not execute the first indication information on the BWP after switching. The first time occasion is a time occasion for receiving the first indication information.

In the embodiments of the present disclosure, the duration and the start time occasion of the BWP switching timer are agreed upon by the protocol or pre-configured by the network device. The network device has already known the duration and the start time occasion of the BWP switching timer based on the protocol or pre-configured information, and can thus know the user equipment's operation to switch BWP in response to timeout of the BWP switching timer.

In an example, the user equipment receives, on BWP1 at time A, the first indication information, for instructing to enable or disable the spatial unit, transmitted by the network device. At time B, the user equipment determines that the BWP switching timer has timed out. At time C, the user equipment switches a BWP in response to timeout of the BWP switching timer, and does not execute the first indication information on the BWP2 after switching. The time A, the time B, and the time C are arranged in sequence from left to right on the timeline.

In some embodiments, the step S503 further includes: using, by the user equipment and the network device a default spatial unit on the BWP after switching. In an embodiment, different spatial units can be configured for different BWPs when configuring spatial units. In the scenario of switching BWP on the user equipment, some spatial units can be configured on the BWP before switching, and other spatial units can be configured on the BWP after switching. When configuring spatial units, the concept of “spatial unit group” can be used or not used, and one or more spatial units can be configured without using the concept of “spatial unit group”. If the user equipment has already been configured with a plurality of default “spatial unit groups” on the BWP after switching, the default spatial unit in step S503 refers to the spatial unit in the default spatial unit group, where the default spatial unit group is agreed upon by the protocol or configured by the network device (for example, the default spatial unit group is a spatial unit group 0). If the user equipment is not configured with any spatial unit group on the BWP after switching, that is, no spatial unit group is configured, the default spatial unit in step S503 refers to all spatial units configured on the BWP after switching.

In some embodiments, the spatial unit is one or more reference signals.

In some embodiments, the spatial unit may be an antenna element, a port, a TRX chain, a beam, or a panel.

In the embodiments of the present disclosure, the user equipment determines that the first indication information is received on the BWP before switching, and it can be considered that the spatial unit to be enabled or disabled as instructed in the first indication information is only applicable to the BWP before switching, so that the user equipment does not execute the first indication information after performing the BWP switching.

An embodiment of the present disclosure provides a method for executing indication information, and the method includes the following steps S501′ to S503′.

At step S501′, The network device transmits third indication information, for instructing to enable at least one spatial unit and to disable at least one spatial unit, to the user equipment.

At step S502′, the user equipment switches a BWP (performs BWP switching) in response to timeout of a BWP switching timer.

At step S503′, the user equipment determines that the first time occasion is before the user equipment performs, based on the BWP switching timer, the BWP switching; and not execute the third indication information on the BWP after switching. The first time occasion is a time occasion for receiving the first indication information.

In some embodiments, the step S403′ further includes: using, by the user equipment and the network device, a default spatial unit on the BWP after switching.

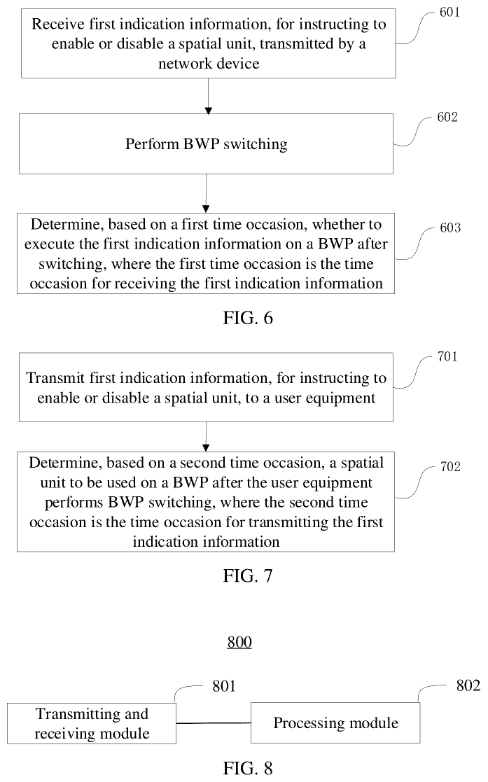

An embodiment of the present disclosure provides a method for executing indication information, which is performed by a user equipment. FIG. 6 is a flowchart illustrating a method for executing indication information according to the embodiment of the present disclosure. As shown in FIG. 6, the method includes the following steps S601 to S603.

At step S601, first indication information, for instructing to enable or disable a spatial unit, transmitted by a network device is received.

At step S602, bandwidth part (BWP) switching is performed.

At step S603, it is determined, based on a first time occasion, whether to execute the first indication information on a BWP after switching, where the first time occasion is a time occasion for receiving the first indication information.

In some embodiments, receiving first indication information, transmitted by the network device, for instructing to enable or disable the spatial unit includes: receiving downlink control information (DCI) transmitted by the network device, where the DCI includes the first indication information for instructing to enable or disable the spatial unit and second indication information for instructing to perform the BWP switching.

Performing the BWP switching includes: performing the BWP switching in response to receiving the second indication information transmitted by the network device.

Determining, based on the first time occasion, whether to execute the first indication information on the BWP after switching includes: determining that the first time occasion is a time occasion for receiving the DCI; and executing the first indication information on the BWP after switching.

In an example, the user equipment starts to execute the first indication information at a first time t1, where the first time t1 is a time corresponding to a set duration after a time for receiving the DCI. For example, if the time of receiving the DCI is t0 and the duration is set to T, the first time t1 is t0+T.

In another example, the user equipment starts to execute the first indication information at a second time t2, where the second time t2 is after receiving the DCI and is separated from a time for receiving the DCI by a slot offset indicated by the DCI. For example, as shown in FIG. 3, the physical downlink control channel (PDCCH) of the DCI for indicating the BWP is located within the first three symbols of slot m. The user equipment performs switches from BWP1 to BWP2 and uses BWP2 in slot n. When a slot offset indicated by the DCI occupies k slots, the time corresponding to the slot offset indicated by the DCI is the end time of slot m+k.

In some embodiments, determining, based on the first time occasion, whether to execute the first indication information on the BWP after switching includes: determining that the first time occasion is before receiving second indication information for instructing to perform the BWP switching; and not executing the first indication information on the BWP after switching.

In some embodiments, the method further includes: using, by the user equipment and the network device, a default spatial unit on the BWP after switching.

In some embodiments, performing the BWP switching includes: performing the BWP switching in response to timeout of a BWP switching timer.

In some embodiments, determining, based on the first time occasion, whether to execute the first indication information on the BWP after switching includes: determining that the first time occasion is before the user equipment performs, based on the BWP switching timer, the BWP switching; and not executing the first indication information on the BWP after switching.

In some embodiments, determining that the first time occasion is before the user equipment performs, based on the BWP switching timer, the BWP switching corresponds to an operation of transmitting and receiving the first indication information on the BWP before switching, In some embodiments, the method further includes: using, by the user equipment and the network device, a default spatial unit on the BWP after switching.

In some embodiments, the spatial unit is one or more reference signals.

In some embodiments, the spatial unit may be an antenna element, a port, a TRX chain, a beam, or a panel.

An embodiment of the present disclosure provides a method for transmitting indication information, which is performed by a network device. FIG. 7 is a flowchart illustrating a method for transmitting indication information according to the embodiment of the present disclosure. As shown in FIG. 7, the method includes the following steps S701 to S702.

At step S701, first indication information for instructing to enable or disable a spatial unit is transmitted to a user equipment; and At step S702, a spatial unit to be used on a bandwidth part (BWP) obtained after the user equipment performs BWP switching is determined based on a second time occasion, where the second time occasion is a time occasion for transmitting the first indication information.

In some embodiments, transmitting the first indication information, for instructing to enable or disable the spatial unit, to the user equipment includes: transmitting downlink control information (DCI) to the user equipment, where the DCI includes the first indication information for instructing to enable or disable the spatial unit and second indication information for instructing to perform the BWP switching.

In some embodiments, determining, based on the second time occasion, the spatial unit to be used on the BWP obtained after the user equipment performs the BWP switching includes: determining that the second time occasion is a time occasion for transmitting the DCI, where the DCI includes the first indication information and second indication information for instructing to perform the BWP switching; and enable the spatial unit, to be enabled as instructed by the first indication information, on the BWP after switching, or disable the spatial unit, to be disabled as instructed by the first indication information, on the BWP after switching.

In some embodiments, the method further includes: transmitting second indication information for instructing to perform the BWP switching after transmitting the first indication information to the user equipment.

In some embodiments, determining, based on the second time occasion, the spatial unit to be used on the BWP obtained after the user equipment performs the BWP switching includes: determining that the second time occasion is before transmitting the second indication information; and using a default spatial unit on the BWP after switching.

In some embodiments, determining, based on the second time occasion, the spatial unit to be used on the BWP obtained after the user equipment performs the BWP switching includes: determining that the second time occasion is before the user equipment performs, based on the BWP switching timer, the BWP switching; and using a default spatial unit on the BWP after switching.

In some embodiments, determining that the second time occasion is before the user equipment performs, based on the BWP switching timer, the BWP switching corresponds to an operation of transmitting the first indication information on the BWP before switching in case that the user equipment performs the BWP switching in response to timeout of the BWP switching timer.

Based on the same conception as the method embodiments, embodiments of the present disclosure further provide a communication device that may have the functions of the user equipment 102 in the method embodiments and be used to perform the steps provided in the above-mentioned embodiments and performed by the user equipment 102. The functions may be implemented by software, or by hardware executing corresponding software. The hardware or software includes one or more modules corresponding to the above-mentioned functions.

In an embodiment, the communication apparatus 800 as shown in FIG. 8 may serve as the user equipment 102 involved in the method embodiments and perform the steps performed by the user equipment 102 in the method embodiments.

The communication apparatus 800 includes a transmitting and receiving module 801, and a processing module 802.

The transmitting and receiving module 801 is configured to: receive first indication information, for instructing to enable or disable a spatial unit, transmitted by a network device; and perform bandwidth part (BWP) switching.

The processing module 802 is configured to determine, based on a first time occasion, whether to execute the first indication information on a BWP after switching, where the first time occasion is a time occasion for receiving the first indication information.

In some embodiments, the transmitting and receiving module 801 is further configured to receive downlink control information (DCI) transmitted by the network device, where the DCI includes the first indication information for instructing to enable or disable the spatial unit and second indication information for instructing to perform the BWP switching.

In some embodiments, the processing module 802 is further configured to: perform the BWP switching in response to receiving the second indication information transmitted by the network device; determine that the first time occasion is a time occasion for receiving the DCI; and execute the first indication information on the BWP after switching.

In some embodiments, the processing module 802 is further configured to: start to execute the first indication information at a first time, where the first time is a time corresponding to a set duration after a time for receiving the DCI.

In some embodiments, the processing module 802 is configured to: start to execute the first indication information at a second time, where the second time is after receiving the DCI and is separated from a time for receiving the DCI by a slot offset indicated by the DCI.

In some embodiments, the processing module 802 is further configured to: determine that the first time occasion is before receiving second indication information for instructing to perform the BWP switching; and not execute the first indication information on the BWP after switching.

In some embodiments, the transmitting and receiving module 801 is further configured to: perform the BWP switching in response to timeout of a BWP switching timer.

In some embodiments, the processing module 802 is further configured to: determine that the first time occasion is before the user equipment performs, based on the BWP switching timer, the BWP switching; and not execute the first indication information on the BWP after switching.

In some embodiments, the processing module 802 is further configured to use a default spatial unit on the BWP after switching.

In some embodiments, the spatial unit is one or more reference signals.

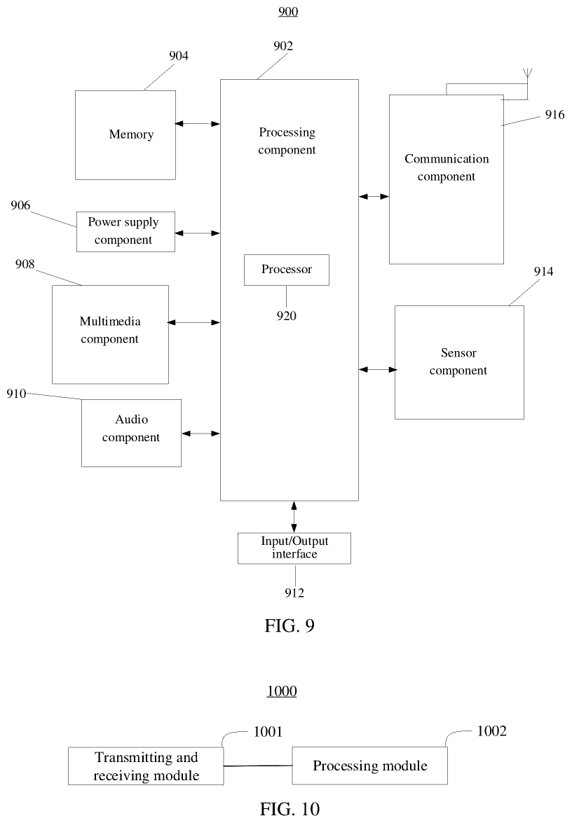

When a communication device is a user equipment 102, its structure may also be shown in FIG. 9.

FIG. 9 is a block diagram illustrating a device 900 for executing indication information according to an embodiment of the present disclosure. For example, the device 900 can be a mobile phone, a computer, a digital broadcast terminal, a message transmitting and receiving device, a gaming console, a tablet device, a medical device, a fitness device, a personal digital assistant, and the like.

Referring to FIG. 9, the device 900 can include one or more of the following components: a processing component 902, a memory 904, a power supply component 906, a multimedia component 908, an audio component 910, an input/output (I/O) interface 912, a sensor component 914, and a communication component 916.

The processing component 902 usually controls overall operations of the device 900, such as operations related to display, a telephone call, data communication, a camera operation and a record operation. The processing component 902 may include one or more processors 920 to execute instructions to complete all or a part of the steps of the above methods. Further, the processing component 902 may include one or more modules to facilitate interaction between the processing component 902 and another component. For example, the processing component 902 may include a multimedia module to facilitate the interaction between the multimedia component 908 and the processing component 902.

The memory 904 is configured to store different types of data to support operations at the device 900. Examples of such data include instructions, contact data, phone book data, messages, pictures, videos, and so on for any application or method that operates on the device 900. The memory 904 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disk.

The power supply component 906 supplies power for different components of the device 900. The power supply component 906 may include a power supply management system, one or more power supplies, and other components associated with generating, managing and distributing power for the device 900.

The multimedia component 908 includes a screen for providing an output interface between the device 900 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 908 may include a front camera and/or a rear camera. When the device 900 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 910 is configured to output and/or input an audio signal. For example, the audio component 910 may include a microphone (MIC). When the device 900 is in an operating mode, such as a call mode, a recording mode and a speech recognition mode, the microphone is configured to receive an external audio signal. The received audio signal may be further stored in the memory 904 or sent via the communication component 916. In some embodiments, the audio component 910 also includes a speaker for outputting an audio signal.

The I/O interface 912 may provide an interface between the processing component 902 and peripheral interface modules. The above peripheral interface modules may include a keyboard, a click wheel, buttons and so on. Such buttons may include but not limited to: a home button, a volume button, a start button and a lock button.

The sensor component 914 includes one or more sensors for providing state assessments in different aspects for the device 900. For example, the sensor component 914 may detect an on/off state of the device 900 and a relative location of components. For example, the components are a display and a keypad of the device 900. The sensor component 914 may also detect a position change of the device 900 or a component of the device 900, presence or absence of a touch of a user on the device 900, an orientation or acceleration/deceleration of the device 900, and a temperature change of the device 900. The sensor component 914 may include a proximity sensor configured to detect presence of a nearby object without any physical contact. The sensor component 914 may also include an optical sensor, such as a CMOS or CCD image sensor used in an imaging application. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the device 900 and other devices. The device 900 may access a wireless network based on a communication standard, such as WiFi, 4G or 5G, or a combination thereof. In some embodiments, the communication component 916 may receive a broadcast signal or broadcast-related information from an external broadcast management system via a broadcast channel. In some embodiments, the communication component 916 may also include a near field communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology and other technologies.

In an example, the device 900 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method in any one of the above examples.

In an example, a non-transitory computer readable storage medium including instructions, such as the memory 904 including instructions, is also provided. The above instructions may be executed by the processor 920 of the device 900 to complete the above method. For example, the non-transitory computer readable storage medium may be a read-only memory (ROM), a random access memory (RAM), a CD-ROM, a magnetic tape, a floppy disk and an optical data storage device, etc.

Based on the same conception as the method embodiments, embodiments of the present disclosure further provide a communication device that may have the functions of the network device 101 in the method embodiments and be used to perform the steps provided in the above-mentioned embodiments and performed by the network device 101. The functions may be implemented by software, or by hardware executing corresponding software. The hardware or software includes one or more modules corresponding to the above-mentioned functions.

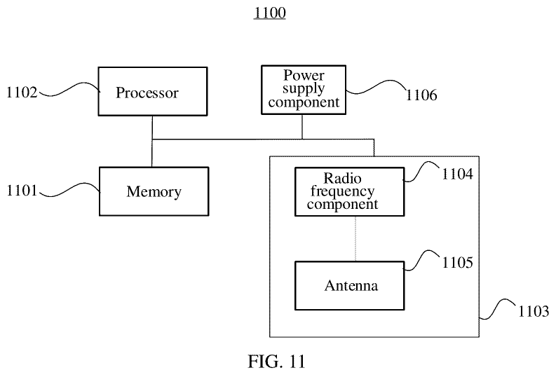

In an embodiment, the communication apparatus 1000 as shown in FIG. 10 may serve as the network device 101 involved in the method embodiments and perform the steps performed by the network device 101 in the method embodiments.

The communication apparatus 1000 shown in FIG. 10 includes a transmitting and receiving module 1001 and a processing module 1002 for performing the steps of the method performed by the network device 101 in the embodiments.

The transmitting and receiving module 1001 is configured to transmit first indication information, for instructing to enable or disable a spatial unit, to a user equipment.

The processing module 1002 is configured to determine, based on a second time occasion, a spatial unit to be used on a BWP obtained after the user equipment performs BWP switching, where the second time occasion is a time occasion for transmitting the first indication information.

In some embodiments, the transmitting and receiving module 1001 is further configured to transmit downlink control information (DCI) to the user equipment, where the DCI includes the first indication information for instructing to enable or disable the spatial unit and second indication information for instructing to perform the BWP switching.

In some embodiments, the processing module 1002 is further configured to: determine that the second time occasion is a time occasion for transmitting the DCI, where the DCI includes the first indication information and second indication information for instructing to perform the BWP switching; and enable the spatial unit, to be enabled as instructed by the first indication information, on the BWP after switching, or disable the spatial unit, to be disabled as instructed by the first indication information, on the BWP after switching.

In some embodiments, the transmitting and receiving module 1001 is further configured to transmit the second indication information for instructing to perform the BWP switching after transmitting the first indication information to the user equipment.

In some embodiments, the processing module 1002 is further configured to determine that the second time occasion is before transmitting the second indication information; and using a default spatial unit on the BWP after switching.

In some embodiments, the processing module 1002 is further configured to determine that the second time occasion is before the user equipment performs, based on the BWP switching timer, the BWP switching; and using a default spatial unit on the BWP after switching.

When a communication device is a network device 101, its structure may also be shown in FIG. 11. As shown in FIG. 11, the communication device 1100 includes a memory 1101, a processor 1102, a transmitting and receiving component 1103, and a power supply component 1106. The memory 1101 is coupled to the processor 1102 and may be configured to store programs and data necessary for the communication device 1100 to implement various functions. The processor 1102 is configured to support the communication device 1100 to perform the corresponding function in the above-mentioned methods, which can be realized by calling the programs stored in the memory 1101. The transmitting and receiving component 1103 may be a wireless transceiver that may be used to support the communication device 1100 to receive signaling and/or data through a radio Interface, as well as to transmit signaling and/or data. The transmitting and receiving component 1103 may also be referred to as a transmitting and receiving unit or a communication unit, and the transmitting and receiving component 1103 may include a radio frequency (RF) component 1104 and one or more antennas 1105, where the RF component 1104 may be a remote radio unit (RRU), which may be specifically used for transmission of RF signals and conversion of RF signals to baseband signals, and the one or more antennas 1105 may be specifically used to perform radiation and reception of RF signals.

When the communication device 1100 needs to transmit data, the processor 1102 can perform baseband processing on the data to be transmitted, and then output a baseband signal to the radio frequency unit, and the radio frequency unit performs radio frequency processing on the baseband signal and then transmits the radio frequency signal in the form of electromagnetic waves through the antenna. When there is data transmitted to the communication device 1100, the radio frequency unit receives the radio frequency signal through the antenna, converts the radio frequency signal to a baseband signal, and outputs the baseband signal to the processor 1102, and the processor 1102 converts the baseband signal to data and processes the data.

After considering the specification and practicing the present disclosure, those skilled in the art would easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the present disclosure is to be limited only by the appended claims.

### Industrial utility

The user equipment determines, based on the time occasion for receiving the first indication information, whether to execute the first indication information, transmitted by the network device, on the BWP after switching, so that in the BWP switching scenario, the user equipment responds to, on the appropriate BWP, the indication, for dynamically enabling the spatial unit, from the network device, and this prevents the user equipment from not responding to, on the BWP expected by the network device, the indication, for dynamically enabling the spatial unit, from the network device due to the BWP switching, or this prevents the user equipment from responding to, on the BWP not expected by the network device, the indication, for dynamically enabling the spatial unit, from the network device. The network device determines, by the time occasion for transmitting the first indication information, the spatial unit to be used on the BWP obtained after the user equipment performs BWP switching, so that in the BWP switching scenario of the user equipment, the network device and the user equipment are consistent in enabling or disabling the spatial unit.

1. A method for executing indication information, performed by a user equipment, and comprising:
receiving first indication information, for instructing to enable or disable a spatial unit, transmitted by a network device;
performing bandwidth part (BWP) switching; and
determining, based on a time occasion, whether to execute the first indication information on a BWP after switching, wherein the time occasion is for receiving the first indication information.

2. The method of claim 1, wherein receiving the first indication information, for instructing to enable or disable the spatial unit, transmitted by a network device, comprises: receiving downlink control information (DCI) transmitted by the network device, wherein the DCI comprises the first indication information for instructing to enable or disable the spatial unit and second indication information for instructing to perform the BWP switching;
performing the BWP switching comprises: performing the BWP switching in response to receiving the second indication information transmitted by the network device;
determining, based on the time occasion, whether to execute the first indication information on the BWP after switching comprises: determining that the time occasion is for receiving the DCI; and executing the first indication information on the BWP after switching.

3. The method of claim 2, further comprising:
starting to execute the first indication information at a first time, wherein the first time is a time corresponding to a set duration after the time for receiving the DCI.

4. The method of claim 2, further comprising:
starting to execute the first indication information at a second time, wherein the second time is after receiving the DCI and is separated from a time for receiving the DCI by a slot offset indicated by the DCI.

5. The method of claim 1, wherein determining, based on the time occasion, whether to execute the first indication information on the BWP after switching comprises: determining that the time occasion is before receiving second indication information; and not executing the first indication information on the BWP after switching.

6. The method of claim 1, wherein performing the BWP switching comprises: performing the BWP switching in response to timeout of a BWP switching timer;
wherein determining, based on the time occasion, whether to execute the first indication information on the BWP after switching comprises: determining that the time occasion is before the user equipment performs, based on the BWP switching timer, the BWP switching; and not executing the first indication information on the BWP after switching.

7. The method of claim 5, further comprising:
using a default spatial unit on the BWP after switching.

8. The method of claim 1, wherein the spatial unit is one or more reference signals.

9. A method for transmitting indication information, performed by a network device, and comprising:
transmitting first indication information, for instructing to enable or disable a spatial unit, to a user equipment; and
determining, based on a second time occasion, a spatial unit to be used on a bandwidth part (BWP) obtained after the user equipment performs BWP switching, wherein the time occasion is for transmitting the first indication information.

10. The method of claim 9, wherein
transmitting the first indication information, for instructing to enable or disable the spatial unit, to the user equipment comprises: transmitting downlink control information (DCI) to the user equipment, wherein the DCI comprises the first indication information for instructing to enable or disable the spatial unit and second indication information for instructing to perform the BWP switching;
determining, based on the time occasion, the spatial unit to be used on the BWP obtained after the user equipment performs the BWP switching comprises:
determining a time occasion for transmitting the DCI; and enabling the spatial unit, to be enabled as instructed by the first indication information, on the BWP after switching, or disabling the spatial unit, to be disabled as instructed by the first indication information, on the BWP after switching.

11. The method of claim 9, further comprising: transmitting second indication information for instructing to perform the BWP switching after transmitting the first indication information to the user equipment;
determining, based on the time occasion, the spatial unit to be used on the BWP obtained after the user equipment performs the BWP switching comprises:
determining that the second time occasion is before transmitting the second indication information; and using a default spatial unit on the BWP after switching.

12. The method of claim 9, wherein determining, based on the time occasion, the spatial unit to be used on the BWP obtained after the user equipment performs the BWP switching comprises:
determining that the time occasion is before the user equipment performs, based on the BWP switching timer, the BWP switching; and using a default spatial unit on the BWP after switching.

13. (canceled)

14. (canceled)

15. An electronic device, comprising:
a processor; and
a memory storing computer programs executable by the processor;
wherein the processor is configured to:
receive first indication information, for instructing to enable or disable a spatial unit. transmitted by a network device;
perform bandwidth part (BWP) switching; and
determine, based on a time occasion, whether to execute the first indication information on a BWP after switching, wherein the time occasion is for receiving the first indication information.

16. An electronic device, comprising:
a processor; and
a memory storing computer programs executable by the processor;
wherein the processor is configured to perform the method of claim 9.

17. A non-transitory computer-readable storage medium, storing instructions thereon, wherein the instructions, when executed by a processor, cause the processor to perform the method of claim 1.

18. A non-transitory computer-readable storage medium, storing instructions thereon, wherein the instructions, when executed by a processor, cause the processor to perform the method of claim 9.

19. The electronic device of claim 15, wherein the processor is further configured to:
receive downlink control information (DCI) transmitted by the network device, wherein the DCI comprises the first indication information for instructing to enable or disable the spatial unit and second indication information for instructing to perform the BWP switching;
perform the BWP switching in response to receiving the second indication information transmitted by the network device; and
determine that the time occasion is for receiving the DCI; and executing the first indication information on the BWP after switching.

20. The electronic device of claim 19, wherein the processor is further configured to:
start to execute the first indication information at a first time, wherein the first time is a time corresponding to a set duration after a time for receiving the DCI; or
start to execute the first indication information at a second time, wherein the second time is after receiving the DCI and is separated from a time for receiving the DCI by a slot offset indicated by the DCI.

21. The electronic device of claim 15, wherein the processor is further configured to:
determine that the time occasion is before receiving second indication information; and not executing the first indication information on the BWP after switching.

22. The electronic device of claim 15, wherein the processor is further configured to:
perform the BWP switching in response to timeout of a BWP switching timer; and
determine that the time occasion is before the user equipment performs, based on the BWP switching timer, the BWP switching; and not execute the first indication information on the BWP after switching.
